(19) United States
(12) Patent Application Publication
(10) Pub. No.: US 2004/0033822 A1
(43) Pub. Date: Feb. 19, 2004

(54) Portable terminal apparatus

(75) Inventors: Toshiyuki Itoh, Kawasaki (JP); Ken Hayashida, Kawasaki (JP); Shinako Watabe, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 10/360,736

(22) Filed: Feb. 10, 2003

(30) Foreign Application Priority Data
Aug. 13, 2002 (JP) 2002-235525

(51) Int. Cl. H04B 1/38

(52) U.S. Cl. 455/575.3; 455/550.1; 455/566

(57) ABSTRACT

A portable terminal apparatus which can be folded by having a movable portion thereof that rotatably moves with respect to a main body portion thereof in means to accommodate the increasing multiple functions of the portable terminal apparatus and to improve operability.

The portable terminal apparatus includes a main body portion, a movable portion rotatably coupled to the main body portion, and at least one operation key disposed on an inner surface of the movable portion, wherein the operation key is positioned within a reach of a finger of a hand holding the main body portion, wherein the operation key is operated with said finger of said hand.

### BACKGROUND OF THE INVENTION

1. Field of the Invention

The present invention generally relates to a portable terminal apparatus, more particularly to a portable terminal apparatus which can be folded by having a movable portion thereof that rotatably moves with respect to a main body portion thereof.

2. Description of the Related Art

In recent years, a portable phone, which is a type of portable terminal apparatus, is provided in various forms. Among the various portable phones, a foldable type portable phone has become widely used. The foldable type portable phone having a movable portion thereof rotatably coupled to a main body portion thereof can be carried in a folded state having the movable portion matched with the main body portion.

In the foldable portable phone, the main body portion has, for example, a microphone, a ten-key, a cursor key, a power key, and a talk key formed thereto, and the movable portion has, for example, a speaker and a liquid crystal display portion (hereinafter referred as “LCD portion”) formed thereto. The movable portion is rotatably connected to the main body portion via a hinge portion, thereby allowing the movable portion to fold with respect to the main body portion.

The foldable type portable phone having such structure has an advantage of preventing inadvertent key-pressing when being carried since the folding of the phone automatically provides protection for each key positioned between the movable portion and the main body portion. When talking on the foldable type portable phone, the movable portion is unfolded into an opened state with respect to the main body portion; thereby allowing the foldable type portable phone to have a longer body length than that of other types of portable phones such as a straight type phone. Accordingly, the microphone and the speaker are distanced from each other, so that the microphone can be suitably positioned closer to the mouth of the user (talker) and the speaker can be suitably positioned closer to the ear of the user, thereby making conversation on the phone easier. Therefore, the foldable type portable phone having these advantages is widely used in recent years.

Meanwhile, owing to the multiple functions added to the portable phone, there is a growing increase in the number of operation keys required for performing such functions. For example, other than the conventional operation keys such as the ten-key or the cursor key, portable phones are now provided with additional operation keys such as a single push dialing key for making a phone call or a memory key for storing electronic mail addresses.

Generally, the user of the foldable type portable phone operates the various operation keys by using his or her thumb while holding the main body portion with the palm of the same hand operating the operation keys. Therefore, conventional operation keys such as the ten-key and the cursor key were all disposed on the main body portion for enabling easy finger-operation.

However, the growing increase in the number of operation keys required for performing the multiple functions has made it impossible for disposing all the operation keys on the main body portion. Therefore, as shown in Japanese patent laid open publication No. 2002-176476, the conventional art proposes to dispose the operation key not only in the main body portion but in the movable portion as well.

The portable phone shown in the Japanese patent laid open publication, however, has an operation key disposed close to a speaker of a movable portion. That is, the operation key arranged in the movable portion is disposed in a position far from the main body portion.

Therefore, the user is unable to operate the operation key disposed far from the main body portion while maintaining to hold the main body portion by the hand. The user is therefore required to change grip of the main body portion in order to reach his or her fingers to the operation key, or otherwise, use the other hand which is not holding the main body portion and operate the operation key with two hands. Therefore, the conventional portable phone lacks operability in operating many operation keys provided thereto.

Furthermore, the conventional operation key disposed on the movable portion is formed in a manner protruding from an inner surface of the movable portion (i.e., the surface facing the main body portion when the portable phone is in a folded state). Therefore, the operation key risks being inadvertently pressed (operated) when placing an ear upon the speaker for talking on the phone. The operation key also risks being inadvertently pressed (operated) when folding the movable portion since the folding of the movable portion causes the operation key protruding from the surface facing the main body portion (inner surface of the main body portion) to make contact with the main body portion.

Taking the foregoing problems into consideration, the present invention is aimed to provide a portable terminal apparatus being able to accommodate the increasing multiple functions of the portable terminal apparatus and also being able to improve operability.

### SUMMARY OF THE INVENTION

It is a general object of the present invention to provide a portable terminal apparatus that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a portable terminal apparatus particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides a portable terminal apparatus, including a main body portion, a movable portion rotatably coupled to the main body portion, and at least one operation key disposed on an inner surface of the movable portion, wherein the operation key is positioned within a reach of a finger of a hand holding the main body portion, and wherein the operation key is operated with said finger of said hand.

In the present invention, disposing the operation key on the inner surface of the movable portion (surface facing the main body portion when the movable portion is in fold position) allows the operation key to face against the main body portion when the portable terminal apparatus is folded. Therefore, the operation key can be prevented from being inadvertently pressed (operated) when the movable portion is in a folded position.

The operation key is positioned within a reach of a finger of a hand holding the main body portion (finger-operable reach). Therefore, even when the operation key is disposed on the movable portion, the operation key can be operated without having to change grip of the main body portion; hence operability of the operation key can be improved.

In another portable terminal apparatus of this invention, the movable portion has a recess portion formed therein, wherein the operation key is disposed within the recess portion, and wherein the recess portion has a predetermined depth greater than a protrusion height of the operation key protruding from a bottom portion of the recess portion.

By disposing the operation key within the recess portion and by forming the depth of the recess portion (h1) greater than the protrusion height of the operation key (h2) (h1>h2), the operation key and the main body portion will not interfere with each other even when the movable portion is rotated to a folded position. Accordingly, inadvertent pressing (operation) of the operation key can be prevented when folding the movable portion and also when the portable terminal apparatus is in a folded state.

In another portable terminal apparatus of this invention, the main body portion has at least a microphone, wherein the movable portion has at least a liquid crystal display portion and a speaker, and wherein the main body portion and the movable portion are rotatably coupled via a hinge portion.

Since the main body portion having at least a microphone and the movable portion having at least a liquid crystal display portion and a speaker are rotatably coupled via a hinge portion, the portable terminal apparatus serves as a foldable type portable phone.

In another portable terminal apparatus of this invention, the operation key is disposed between the liquid crystal display portion and the hinge portion.

Since the position of the operation key (i.e. the portion between the liquid crystal display portion and the hinge portion) is a position within the finger-operable reach for enabling the operation key to be operated with a finger of a hand holding the main body portion, operability of the operation key can be improved.

In another portable terminal apparatus of this invention, the operation key is a function key assigned to perform one or more functions.

The user will not experience stress (e.g. fatigue upon fingers) even when using the function key for numerous amount of times since the function key is disposed within the finger-operable reach for enabling the operation key to be operated with a finger of a hand holding the main body portion.

Other objects and further features of the present invention will be apparent from the following detailed description when read in conjunction with the accompanying drawings.

### BRIEF DESCRIPTION OF THE DRAWINGS

FIG. 1A is a front view showing a movable portion in an opened state, FIG. 1B is a side view showing a movable portion in an opened state, and FIG. 1C is a rear view showing a movable portion in an opened state;

FIG. 2A is a front view showing a movable portion in a folded state, FIG. 2B is a side view showing a movable portion in a folded state, FIG. 2C is a rear view showing a movable portion in a folded state;

FIG. 3 is an enlarged view showing the proximity of an operation key; and

FIG. 4 is a cross-sectional view along line A-A of FIG. 3.

### DESCRIPTION OF THE PREFERRED EMBODIMENTS

In the following, embodiments of the present invention will be described with reference to the accompanying drawings.

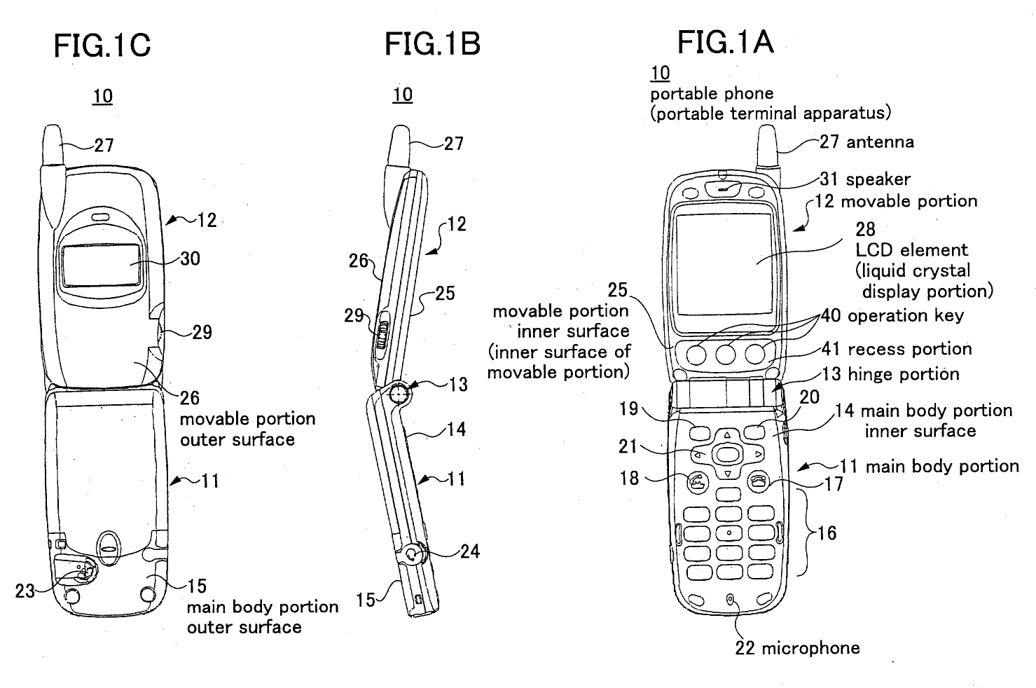

An example of an entire structure of a portable terminal apparatus will be hereinafter described with reference to FIG. 1A to FIG. 3. In the following example, a portable phone will be used for explaining the portable terminal apparatus.

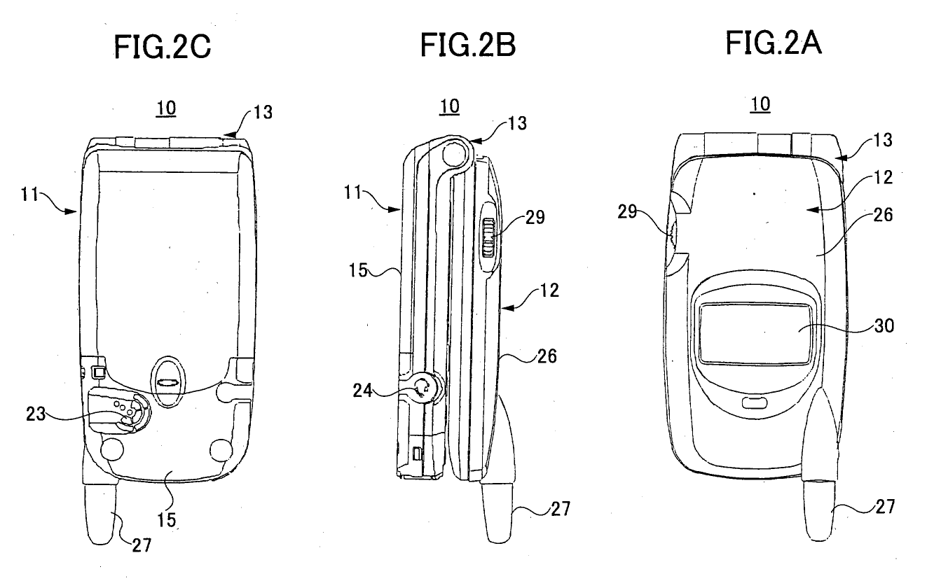

An entire structure of a portable phone 10 will be explained with reference to FIGS. 1A to 2C. The portable phone 10 is basically formed of, for example, a main body portion 11, a movable portion 12 and a hinge portion 13.

The hinge portion 13 enables the movable portion 12 to rotate with respect to the main body portion 11. FIGS. 1A to 1C show a state where the portable phone 10 has the movable portion 12 rotated with respect to the main body portion 11 and situated in an opened position. In such state, a user operates various operation keys to talk on the phone or perform various functions of the portable phone 10. FIGS. 2A to 2C show a state where the portable phone 10 has the movable portion 12 rotated with respect to the main body portion 11 and situated in a folded position facing the main body portion 11 (hereinafter referred as “folded state”). The portable phone 10 is carried in thus folded state.

The main body portion 11, the movable portion 12 and the hinge portion 13 of the portable phone 10 will hereinafter be described in detail.

The main body portion 11 has a main body inner surface 14 arranged in a position facing the movable portion 12 during the folded state. Numerous keys including, for example, ten-key 16, a power key 17, a talk key 18, a menu key 19, a phone book key 20, and a cursor movement key 21 are disposed on the main body inner surface 14. A microphone 22 is disposed in a furthest position from the hinge portion 13 of the main body portion 11. An earphone jack 24 is disposed on a side surface portion of the main body portion 11. An external speaker 23 is disposed on a main portion outer surface 15 of the main body portion 11.

Each of the operation keys 16 to 21 disposed on the main body portion 11, which serve as standard operation keys for the portable phone 10, have been used conventionally. The operation keys 16 to 21 are densely disposed on the main body inner surface 14 of the main body portion 11 as shown in FIG. 1A.

The movable portion 12 has a movable portion inner surface (inner surface of the movable portion) 25 arranged in a position facing the main body portion 12 when in the folded state. The movable portion inner surface 25 has a liquid crystal display element 28 (hereinafter referred as “LCD element”), a speaker 31, and an antenna 7 which is disposed on a top portion thereof. As shown in FIG. 1C and FIG. 2A, a rear side liquid crystal display element 30 (hereinafter referred as “rear side LCD”) is disposed on a movable portion outer surface 26 of the movable portion 12.

Disposing the rear side LCD 30 on the movable portion outer surface 26 enables reception of phone calls or electronic mail to be recognized from the rear side LCD 30 even when the portable phone 10 is in a folded state. A volume key 29 for volume adjustment is disposed on a side portion of the movable portion 12.

The portable phone 10 of this embodiment has an operation key 40 disposed on the movable portion 12. The operation key 40 serves as a key for performing various functions of the portable phone 10, for example, a single push dialing key for making a telephone call or a memory key for storing electronic mail addresses.

Note is now to be made to the position of the operation key 40. Tn this embodiment, the operation key 40 is disposed on the movable portion inner surface 25 of the movable portion 12, and in a position between the hinge portion 13 and the LCD element 28 of the movable portion 12. That is, the operation key 40 is disposed on the movable portion inner surface 25, and in a position proximal to the main body portion 11.

Accordingly, along with the other operation keys 16 to 21, the operation key 40 disposed on the movable portion inner surface 25 will be positioned between the main body portion 11 and the movable portion 12 when the movable portion 12 is in the folded state (see FIG. 2B). That is, the operation key 40 will be positioned facing against the main body portion 11.

Therefore, the operation key 40 cannot be operated when the movable portion 12 is in a folded position, and thereby preventing the operation key 40 from being inadvertently pressed when the portable phone 10 is carried when not in use. By preventing the operation key 40 from being inadvertently pressed, an unnecessary consumption of electric power can be restrained and shortening of waiting time as well as inadvertent transmission can be prevented.

As described above, the operation key 40 is disposed in a position proximal to the main body portion 11 (the position between the hinge portion 13 and the LCD element 28). The position of the operation key 40 is predetermined to be within a finger-operable reach, that is, a reach for the user to operate the operation key 40 while holding the main body portion 11 with the same hand for operating the operation key 40.

The user generally single handedly operates the portable phone 10 while holding the main body portion 11 with the same hand operating the portable phone 10. Each operation key 16 to 21 is usually operated with the use of a thumb. This embodiment has a feature of disposing the operation key 40 on the movable portion 12 within the reach for enabling finger-operation while holding a typical portable phone 10 in a conventional manner (a manner where the portable phone 10 is held with the same hand for performing the finger-operation).

Therefore, even when the operation key 40 is disposed on the movable portion 12, the user would not have to switch his or her hand for holding the main body portion 11, nor does the user have to use two hands for operating the operation key since the operation key is positioned in a predetermined reach for enabling finger-operation. Accordingly, operability of the operation key 40 can be improved. In this embodiment, the operation key 40 serve as a function key, for example, a single push dialing key, a memory key, or a setting key for setting a variety of functions. Disposing the operation key 40 within the reach for enabling finger-operation also relieves the user from experiencing stress (e.g. fatigue upon fingers) even when using the operation key 40 for numerous times.

Therefore, regardless of the increase in the number of functions added to the portable phone 10, this embodiment will still be able to provide an excellent operability by disposing the operation key 40 on the movable portion 12 within the reach for enabling finger-operation. That is, the portable phone 10 will be able to provide a vast variety of functions while providing an excellent operability.

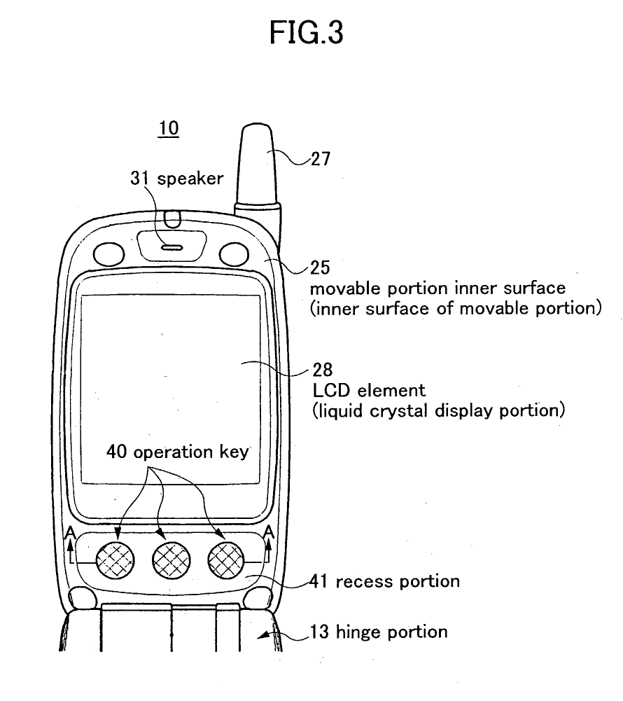

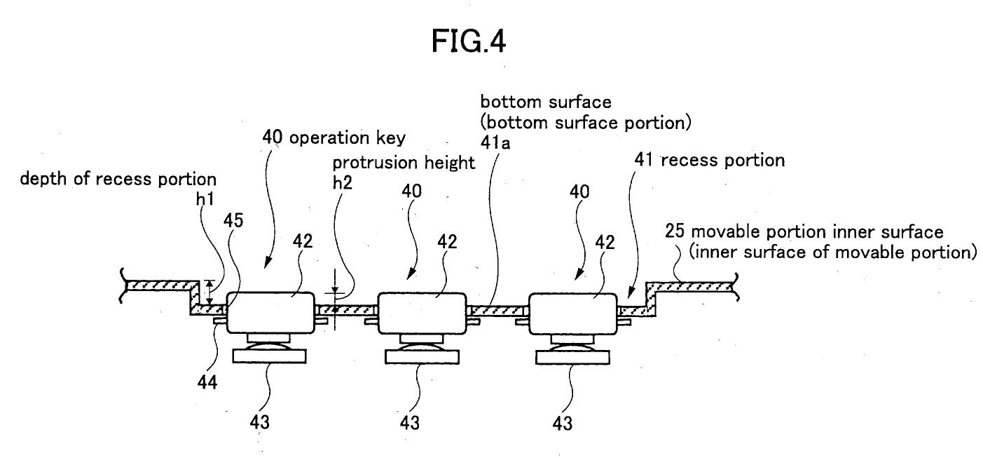

Note is now to be made to the height (level) of the operation key 40 and the movable portion inner surface 25. FIG. 4 is a cross-sectional view along line A-A of FIG. 3. As shown in FIG. 4, the operation key 40 is disposed in a recess portion 41 formed in the movable portion inner surface 25 (movable portion 12).

Each one of the plurality of operation keys 40 (three keys in this embodiment) is composed of a switch knob 42 and a switch main body 43. The switch main body 43 is disposed on a base (not shown) arranged in the movable portion 12, and the switch knob 42 is disposed above an upper portion of the switch main body 43.

An opening portion 45 is formed in a bottom surface (bottom surface portion) 41a of the recess portion 42. The switch knob 42 protrudes into the recess portion 41 from the opening portion 45. The switch main portion 43 electrically switches ON and OFF in accordance with the depressing of the switch knob 42. It is to be noted that a brim portion 44 is formed for preventing the switch knob 42 from detaching from the movable portion inner surface 25.

Note is now to be made to the depth of the recess portion 41 (h1, depth from the movable portion inner surface 25), and also to the protrusion height h2 of the switch knob 42 (height from the bottom surface (bottom surface portion) 41a of the recess portion 41. In this embodiment, the depth of the recess portion 41 (h1) is predetermined to be greater than the protrusion height of the switch knob (operation key 40) (h2) as shown in FIG. 4 (h1>h2).

Thus structured, the operation key 40 can be prevented from interfering with the main body portion 11 when the movable portion 12 is rotated to the folded position shown in FIGS. 2A to 2C. Inadvertent pressing of the operation key 40 can be prevented when folding the movable portion 12 or when the movable portion 12 is in the folded state (i.e. when the portable phone 10 is not in use or when the portable phone 10 is carried). Accordingly, by preventing the operation key 40 from being inadvertently pressed, an unnecessary consumption of electric power can be restrained, shortening of waiting time as well as inadvertent transmission can be prevented. Furthermore, the portable phone 10 can be formed in a thin size since the main body portion 11 and the movable portion 12 require no particular space for disposing the operation key 40 therebetween.

Although a single push dialing key for making a telephone call or a memory key for storing electronic mail addresses is given as an example for the operation key of this embodiment, other keys may also be disposed on the movable portion 12 within the reach for enabling finger-operation. In such a case, the key disposed on the movable portion 12 is not necessarily required to be a new operation key (function key) for performing a newly added function. That is, an operation key for performing a conventional preexisting function may be disposed on the movable portion 12 while the new operation key for performing a newly added function is disposed on the main body portion 11.

Accordingly, the present invention is able to provide the following advantages.

The present invention can prevent inadvertent pressing of the operation key, and can also improve operability of the operation key.

The present invention not only can prevent inadvertent pressing of the operation key when folding the movable portion or when the movable portion is in a folded state, but can also form the entire portable terminal apparatus into a thin size.

The present invention enables the portable terminal apparatus to serve as a foldable type portable phone.

The present invention improves operability of the operation key by disposing the operation key in a position between the liquid crystal display portion and the hinge portion, that is, a position within the reach for allowing finger-operation while the main body portion is held with the same hand in performing the finger-operation.

The present invention relieves the user from experiencing stress even when using the function key (operation key) for numerous times.

Further, the present invention is not limited to these embodiments, but various variations and modifications may be made without departing from the scope of the present invention.

The present application is based on Japanese priority application No. 2002-235525 filed on Aug., 13, 2002 with the Japanese Patent Office, the entire contents of which are hereby incorporated by reference.

What is claimed is:

1. A portable terminal apparatus, comprising:
a main body portion;
a movable portion rotatably coupled to the main body portion; and
at least one operation key disposed on an inner surface of the movable portion,
wherein the operation key is positioned within a reach of a finger of a hand holding the main body portion, wherein the operation key is operated with said finger of said hand.

2. The portable terminal apparatus as claimed in claim 1, wherein the movable portion has a recess portion formed therein, wherein the operation key is disposed within the recess portion, wherein the recess portion has a predetermined depth greater than a protrusion height of the operation key protruding from a bottom surface portion of the recess portion.

3. The portable terminal apparatus as claimed in claim 1, wherein the main body portion has at least a microphone, wherein the movable portion has at least a liquid crystal display portion and a speaker, wherein the main body portion and the movable portion are rotatably coupled via a hinge portion.

4. The portable terminal apparatus as claimed in claim 1, wherein the operation key is disposed between the liquid crystal display portion and the hinge portion.

5. The portable terminal apparatus as claimed in claim 1, wherein the operation key is a function key assigned to perform one or more functions.

6. A portable terminal apparatus, comprising:
a main body portion;
a movable portion rotatably coupled to the main body portion via a hinge portion; and
at least one operation key disposed on an inner surface of the movable portion,
wherein the movable portion has at least a liquid crystal display portion formed on the inner surface thereof, wherein the operation key is disposed between the hinge portion and the liquid crystal display portion.
